(19) United States
(12) Patent Application Publication
(10) Pub. No.: US 2014/0055714 A1
(43) Pub. Date: Feb. 27, 2014

(54) LIQUID CRYSTAL DISPLAY DEVICE WITH A TOUCH PANEL

(71) Applicant: Panasonic Liquid Crystal Display Co., Ltd., Himeji-shi (JP)

(72) Inventors: Masaki TSUBOKURA, Osaka (JP); Takeki SATO, Osaka (JP); Naoki IWASAKI, Osaka (JP)

(73) Assignee: Panasonic Liquid Crystal Display Co., Ltd., Himeji-shi (JP)

(21) Appl. No.: 13/971,106

(22) Filed: Aug. 20, 2013

(30) Foreign Application Priority Data
Aug. 21, 2012 (JP) 2012-182792

(51) Int. Cl. G06F 3/041

(52) U.S. Cl. CPC G06F 3/0412
USPC 349/61

(57) ABSTRACT

Provided is a liquid crystal display device with a touch panel, including a fixing member (5A) for fixing the liquid crystal display panel (2) and the backlight unit (4) to each other. The fixing member (5A) includes: a first end portion (51) attached to a peripheral edge portion of the display surface (2a) of the liquid crystal display panel (2), the peripheral edge portion being devoid of the adhesive layer (6); a second end portion (52) attached to an outer surface of the backlight unit (4); and a non-adhesive portion (53) located between the first end portion (51) and the second end portion (52), the non-adhesive portion (53) being brought into contact with the outer surface of the backlight unit (4) and prevented from adhering to the outer surface.

### CROSS-REFERENCE TO RELATED APPLICATION

The present application claims priority from Japanese application JP 2012-182792 filed on Aug. 21, 2012, the entire content of which is hereby incorporated by reference into this application.

### TECHNICAL FIELD

The present application relates to a liquid crystal display device with a touch panel, and more particularly, to a fixation of a backlight unit.

### BACKGROUND

In a liquid crystal display device disclosed in Japanese Patent Application Laid-open No. 2011-27879, in order to fix a liquid crystal display panel and a backlight unit to each other, adhesive tape is attached in a region from a peripheral edge of a display surface of the liquid crystal display panel to an outer surface of the backlight unit.

By the way, after an assembly haying the liquid crystal display panel and the backlight unit fixed to each other by the adhesive tape is constructed as in Japanese Patent Application Laid-open No. 2011-27879, when the backlight unit is required to be removed from the assembly for a reason of a trouble in the backlight unit or the like, the adhesive tape is peeled off from the outer surface of the backlight unit. At this time, the adhesive tape becomes wrinkled, and hence the adhesive tape cannot be reused. Therefore, the adhesive tape itself needs to be replaced.

However, when a touch panel is attached to the display surface of the liquid crystal display panel, the end portion of the adhesive tape is inserted through a slight gap between the liquid crystal display panel and the touch panel, and hence replacement of the adhesive tape is difficult. The replacement of the adhesive tape may be facilitated by peeling apart the touch panel and the liquid crystal display panel that are attached to each other, but there is a fear in that the liquid crystal display panel or the touch panel is damaged at the time of peeling.

The present application has been made in view of the above-mentioned circumstances, and has a main object to provide a liquid crystal display device with a touch panel, which is excellent in reworkability.

### SUMMARY

In order to solve the above-mentioned problem, according to one embodiment of the present application, there is provided a liquid crystal display device with a touch panel, including: a liquid crystal display panel; a touch panel attached to a display surface of the liquid crystal display panel through intermediation of an adhesive layer; a backlight unit arranged on a back surface side of the liquid crystal display panel; and a fixing member for fixing the liquid crystal display panel and the backlight unit to each other. The fixing member includes: a first end portion attached to a peripheral edge portion of the display surface of the liquid crystal display panel, the peripheral edge portion being devoid of the adhesive layer; a second end portion attached to an outer surface of the backlight unit; and a non-adhesive portion located between the first end portion and the second end portion, the non-adhesive portion being brought into contact with the outer surface of the backlight unit and prevented from adhering to the outer surface.

Further, according to one embodiment of the present application, the fixing member may include adhesive tape in which the first end portion includes an adhesive layer, and a part other than the first end portion is devoid of the adhesive layer, and the second end portion may be attached to the outer surface of the backlight unit by a separate adhesive member.

Further, according to one embodiment of the present application, the fixing member may include adhesive tape in which each of the first end portion and the second end portion includes an adhesive layer, and a part between the first end, portion and the second end portion is devoid of the adhesive layer.

Further, according to one embodiment of the present application, the fixing member may include an L-shaped rigid member including: a first side portion including the first end portion, the first side portion being opposed to the touch panel; and a second side portion including the second end portion, the second side portion being opposed to a side surface of the backlight unit.

Further, according to one embodiment of the present application, the fixing member may include adhesive tape that is devoid of an adhesive layer in a part coming into contact with a part of the outer surface of the backlight unit, which is opposed to the touch panel.

Further, according to one embodiment of the present application, the liquid crystal display device with a touch panel may further include another fixing member attached to a back surface of the touch panel and the outer surface of the backlight unit, the another fixing member fixing the touch panel and the backlight unit to each other.

According to one embodiment of the present application, there is provided a liquid crystal display device with a touch panel, including: a liquid crystal display panel; a touch panel attached to a display surface of the liquid crystal display panel through intermediation of an adhesive layer; a backlight unit arranged on a back surface side of the liquid crystal display panel; and a fixing member for fixing the touch panel and the backlight unit to each other. The fixing member is attached to a back surface of the touch panel and an outer surface of the backlight unit.

According to the embodiments of the present application, the fixing member includes the non-adhesive portion, and hence even when the second end portion is peeled off from the outer surface: of the backlight unit, the fixing member has a small risk of being unable to be reused.

### BRIEF DESCRIPTION OF THE DRAWINGS

In the accompanying drawings:

FIG. 1 is an exploded perspective view of a liquid crystal display device with a touch panel;

FIG. 2 is a sectional view of the liquid crystal display device with a touch panel;

FIG. 3 is a schematic view illustrating a fixing member according to a first embodiment of the present application;

FIG. 4 is a schematic view illustrating a fixing member according to a second embodiment of the present application;

FIG. 5 is a schematic view illustrating a fixing member according to a third embodiment of the present application;

FIG. 6 is a schematic view illustrating a fixing member according to a fourth embodiment of the present application;

FIG. 7 is a schematic view illustrating a fixing member according to another embodiment of the present application; and

FIG. 8 is a schematic view illustrating fixing members according to still another embodiment of the present application.

### DETAILED DESCRIPTION

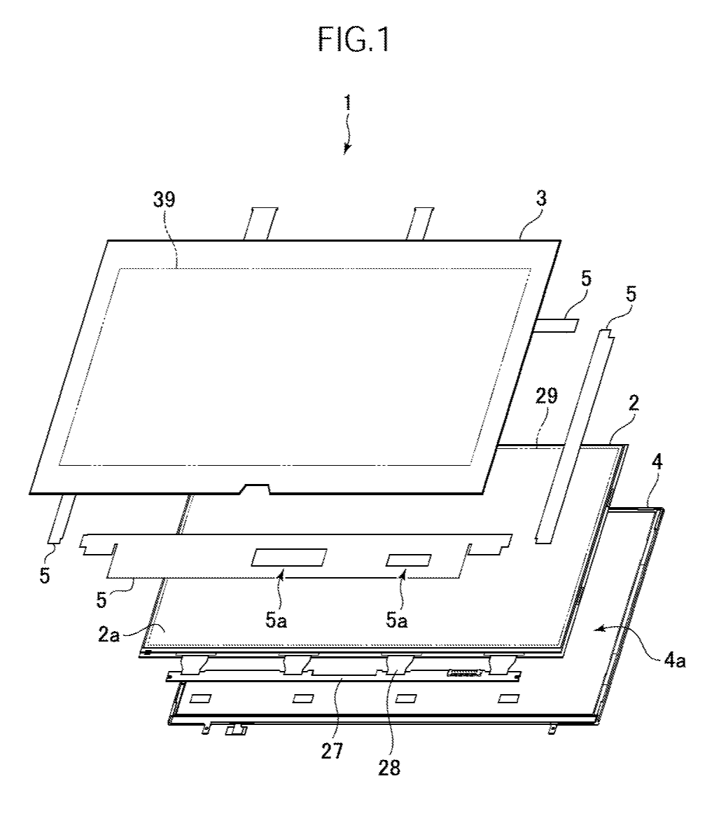

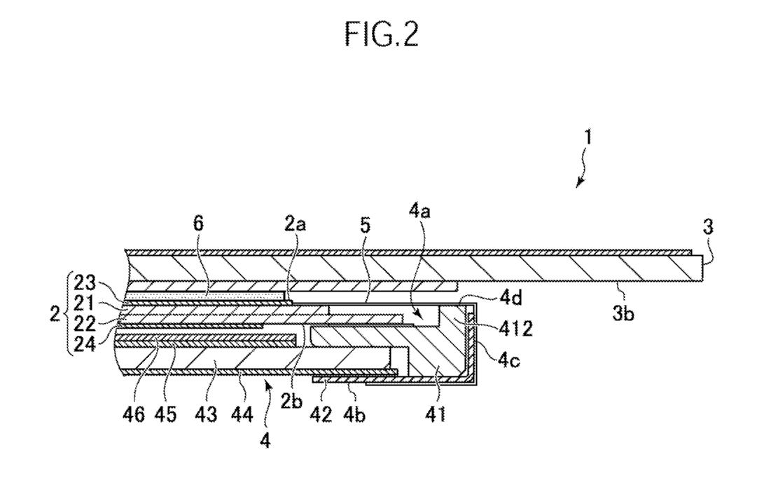

A liquid crystal display device with a touch panel according to an embodiment of the present application is described with reference to the drawings. FIGS. 1 and 2 are an exploded perspective view and a sectional view, respectively, of a liquid crystal display device 1 with a touch panel. The liquid crystal display device 1 with a touch panel includes a liquid crystal display panel 2, a touch panel 3 arranged on a display surface 2a side of the liquid crystal display panel 2, and a backlight unit 4 arranged on a back surface 2b side of the liquid crystal display panel The liquid crystal display panel 2 includes a CF substrate 21 including color filters, and a TFT substrate 22 including thin film transistors. Liquid crystal is held between the CF substrate 21 and the TFT substrate 22. Further, the liquid crystal display panel 2 includes polarizing plates 23 and 24 arranged so as to sandwich the CF substrate 21 and the TFT substrate 22. Further, the liquid crystal display panel 2 includes a plurality of FPCs 27 outwardly extending from an edge portion of the liquid crystal display panel. 2, and connectors 20 connected to end portions of the FPCs 27. Note that, in this specification, the display surface 2a refers to the entire surface of the liquid crystal display panel 2, which is opposed to the touch panel 3, and is not limited to the surface of the polarizing plate 23.

The liquid crystal display panel 2 is attached to a back surface 3b of the touch panel 3 through intermediation of a transparent adhesive layer 6. A rectangular region of the display surface 2a of the liquid crystal display panel 2 excluding a peripheral edge portion thereof is referred to as an adhering region 29, and the adhesive layer 6 is arranged between the adhering region 29 and an adhering region 39 of the back surface 3b of the touch panel 3, which corresponds to the adhering region 29. Specifically, the adhesive layer 6 is arranged on the polarizing plate 23 of the liquid crystal display panel 2. The adhesive layer 6 may be, for example, transparent double-sided adhesive tape or a transparent resin-based adhesive.

The backlight unit 4 has a recessed portion 4a on the side opposed to the liquid crystal display panel 2, and the liquid crystal display panel 2 is received in the recessed portion 4a. The backlight unit 4 includes a first frame portion 41 and a second frame portion 42 each having a rectangular frame shape, a light guide member 43 held by the first and second frame portions 41 and 42, a reflective sheet 44 arranged on the back surface side of the light guide member 43, and a plurality of optical sheets 45 and 46 arranged between the liquid crystal display panel 2 and the light guide member 43. The first frame portion 41 includes a protruding portion 412 that protrudes toward the touch panel 3 to form the recessed portion 4a.

Further, the liquid crystal display device 1 with a touch panel includes a fixing member 5 for fixing the liquid crystal display panel 2 and the backlight unit 4 to each other. The fixing member 5 is formed of, for example, adhesive tape, and is attached to the peripheral edge portion of the display surface 2a of the liquid crystal display panel 2, in which the adhesive layer 6 is not formed, and to the outer surface of the backlight unit 4.

The liquid crystal display device 1 with a touch panel is manufactured as follows. Under a state in which one end portion of the fixing member 5 is attached to the peripheral edge portion of the display surface 2a of the liquid crystal display panel 2, in which the adhesive layer 6 is not formed, the touch panel 3 is attached to the display surface 2a of the liquid crystal display panel 2 through intermediation of the adhesive layer 6. After that, the other end portion of the fixing member 5 is attached to the outer surface of the backlight unit 4 arranged on the back surface 2b side of the liquid crystal display panel

Note that, the FPCs 27 and the connectors 28 provided to the liquid crystal display panel 2 are rolled together with the fixing member 5 so as to be arranged along the outer surface of the backlight unit 4. The fixing member 5 has openings 5a formed therein so as to expose terminals provided to the respective connectors 28 to the outside.

Now, the fixing member 5 according to each embodiment of the present application is described. Note that the structures overlapping among the respective embodiments are denoted by the same reference symbols to omit the detailed description.

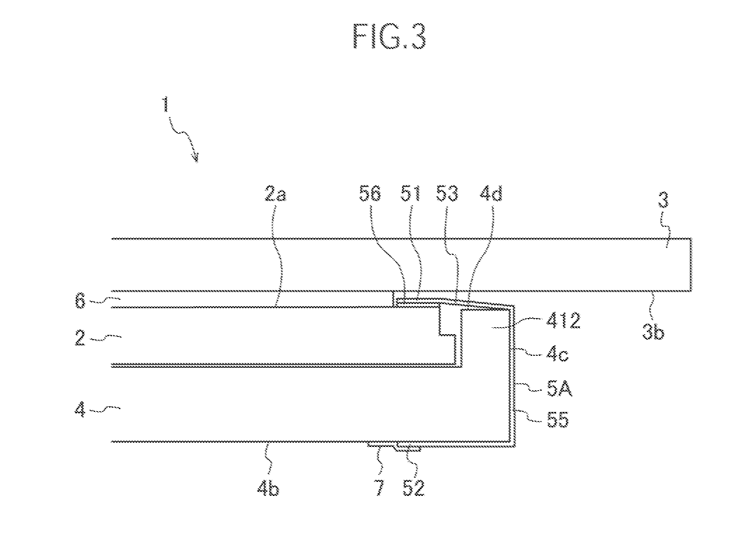

FIG. 3 is a schematic view illustrating a fixing member 5A according to a first embodiment of the present application. The fixing member 5A is adhesive tape including a band-like base layer 55 formed of a sheet member made of a resin material. The fixing member 5A includes a first end portion 51 attached to the peripheral edge portion of the display surface 2a of the liquid crystal display panel 2, and only the first end portion 51 includes an adhesive layer 56 made of a resin-based adhesive. No adhesive layer is provided on a part of the fixing member 5A other than the first end portion 51. The fixing member 5A includes a second end portion 52 on the opposite side to the first end portion 51. The second end portion 52 is attached to a back surface 4b of the backlight unit 4 by an adhesive member 7 formed of, for example, adhesive tape. A part of the fixing member 5A, which does not include the adhesive layer 56, is referred to as a non-adhesive portion 53 in which the base layer 55 is exposed. The non-adhesive portion 53 is merely brought into contact with the back surface 4b, a side surface 4c, and an opposing surface 4d of the backlight unit 4.

According to this embodiment, a state in which only the first end portion 51 of the fixing member 5A is attached to the display surface 2a of the liquid crystal display panel 2 is established merely by peeling off the adhesive member 7 for adhering the second end portion 52 of the fixing member 5A to the back surface 4b of the backlight unit 4. Under this state, the backlight unit 4 can be removed. Further, the non-adhesive port ion 53 of the fixing member 5A does not include the adhesive layer, and hence the fixing member 5A is not wrinkled due to adhesion to the back surface 4b, the side surface 4c, and the opposing surface 4d of the backlight unit 4 or due to adhesion between the adhesive layers. Thus, the fixing member 5A can be easily reused.

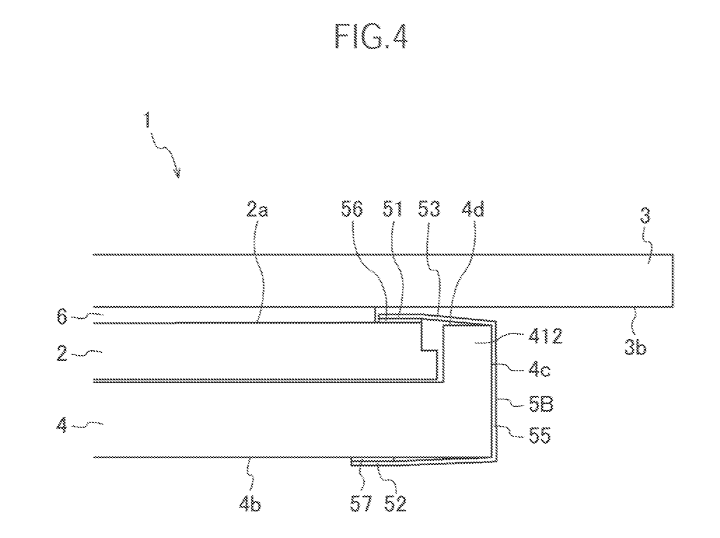

FIG. 4 is a schematic view illustrating a fixing member 58 according to a second embodiment of the present application. The fixing member 58 is also adhesive tape including the band-like base layer 55 formed of a sheet member made of a resin material. The fixing member 5B includes the first end portion 51 that is attached to the peripheral edge portion. of the display surface 2a of the liquid crystal display panel 2, and includes the adhesive layer 56 made of a resin-based adhesive. The fixing member 5B includes the second end portion 52 that is attached to the back surface 4b of the backlight unit 4, and also includes an adhesive layer 57 made of a resin-based adhesive. No adhesive layer is provided in a region between the first end portion 51 and the second end portion

A part of the fixing member 5B, which does not include the adhesive layers 56 and 57, is referred to as the non-adhesive portion 53 in which the base layer 55 is exposed. The non-adhesive portion 53 is merely brought into contact with the back surface 4b, the side surface 4c, and the opposing surface 4d. of the backlight unit 4.

According to this embodiment, a state in which only the first end portion 51 of the fixing member 5B is attached to the display surface 2a of the liquid crystal display panel 2 is established merely by peeling off the second end portion 52 of the fixing member 5B. from the back surface 4b of the backlight unit 4. Under this state, the backlight on it 4 can be removed. Further, the non-adhesive portion 53 of the fixing member 5B does not include the adhesive layer, and hence the fixing member 5B is not wrinkled due to adhesion to the back surface 4b, the side surface 4c, and the opposing surface 4d of the backlight unit 4 or due to adhesion between the adhesive layers. Thus, the fixing member 5B can be easily reused.

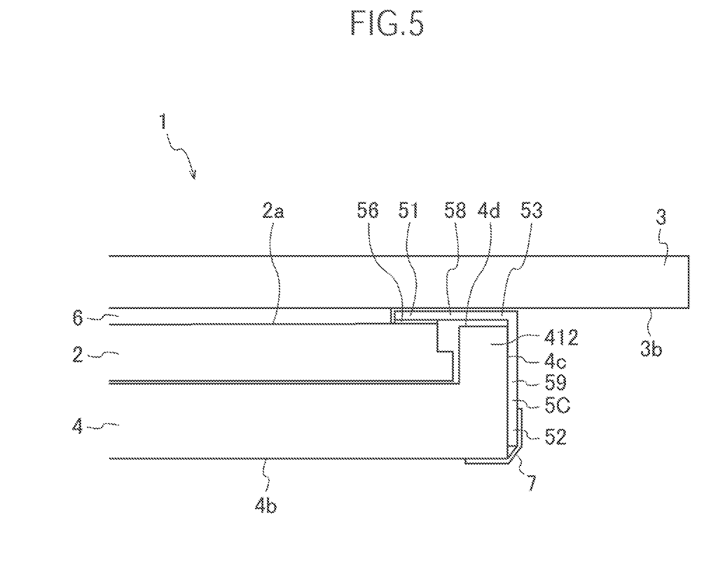

FIG. 5 is a schematic view illustrating a fixing member SC according to a third embodiment of the present application. The fixing member SC is an L-shaped rigid member made of a resin material, and includes a first side portion 58 opposed to the back surface 3b of the touch panel 3, and a second side portion 59 opposed to the side surface 4c of the backlight unit 4. The first side portion 58 is inserted through a gap between the peripheral edge portion of the display surface 2a of the liquid crystal display panel and the back surface 3b of the touch panel 3, and through a gap between the opposing surface 4d of the backlight unit 4 and the back surface 3b of the touch panel 3. The first side portion 58 includes the first end portion 51 including the adhesive layer 56 made of a resin-based adhesive, which is attached to the peripheral edge portion of the display surface 2a of the liquid crystal display panel 2. The second side portion 59 includes the second end portion 52 attached to the side surface 4c of the backlight unit 4 by the adhesive member 7 formed of, for example, adhesive tape. A part of the fixing member 5C, which does not include the adhesive layer 56, is referred to as the non-adhesive port ion 53, and the non-adhesive portion 53 is merely brought into contact with the side surface 4c of the backlight unit 4.

According to this embodiment, a state in which only the first end portion 51 of the fixing member 5C is attached to the display surface 2a of the liquid crystal display panel 2 is established merely by peeling off the adhesive member 7 for adhering the second end portion 52 of the fixing member 5C to the side surface 4c of the backlight unit 4. Under this state, the backlight unit 4 can be removed. Further, the fixing member 5C is a rigid member, and hence the fixing member 5C is not wrinkled. Thus, the fixing member 5C can be easily reused. Further, the fixing member 5C serves as a guide for arranging the backlight unit 4 on the back surface 2b side of the liquid crystal display panel 2, and hence the manufacture of the liquid crystal display device 1 with a touch panel is facilitated.

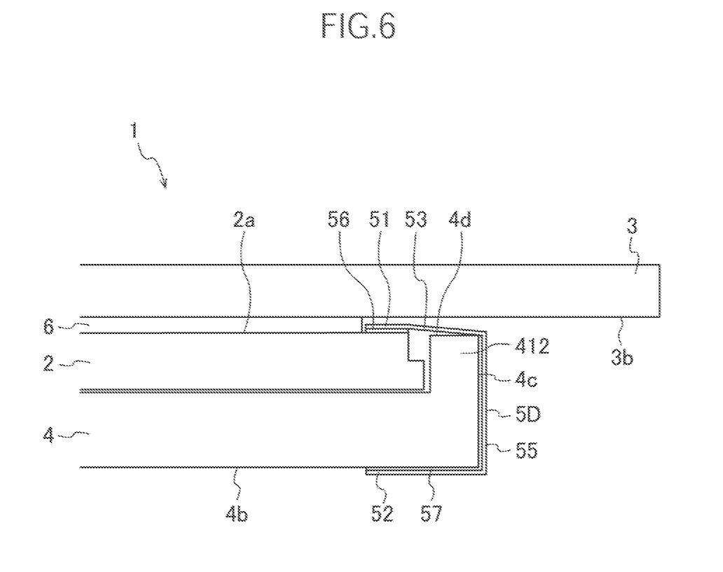

FIG. 6 is a schematic view illustrating a fixing member 5D according to a fourth embodiment of the present application. The fixing member 5D is adhesive tape including the band-like base layer 55 formed of a sheet member made of a resin material. The fixing member 5D includes the adhesive layer 56 that is made of a resin-based adhesive and attached to the peripheral edge portion of the display surface 2a of the liquid crystal display panel 2, and the adhesive layer 57 that is made of a resin-based adhesive and attached to the back surface 4b and the side surface 4c of the backlight unit 4. No adhesive layer is provided in a region between the adhesive layers 56 and 57. A part of the fixing member 5D, which does not include the adhesive layers 56 and 57, is referred to as the non-adhesive portion 53 in which the base layer 55 is exposed. The non-adhesive portion 53 is merely brought into contact with the opposing surface 4d of the backlight unit 4, which is opposed to the touch panel 3. That is, the fixing member 5D does not include the adhesive layer in a part that comes into contact with the opposing surface 4d of the backlight unit 4.

There is no sufficient gap between the opposing surface 4d of the backlight unit 4 and the back surface 3b of the touch panel 3, and hence, when the adhesive tape adheres to the opposing surface 4d of the backlight unit 4, it is difficult to peel off the adhesive tape. Therefore, as in this embodiment, by preventing the adhesive layers 56 and 57 from being formed on at least a part of the fixing member 5D, which is brought into contact with the opposing surface 4d of the backlight unit 4, the backlight unit 4 can be easily removed.

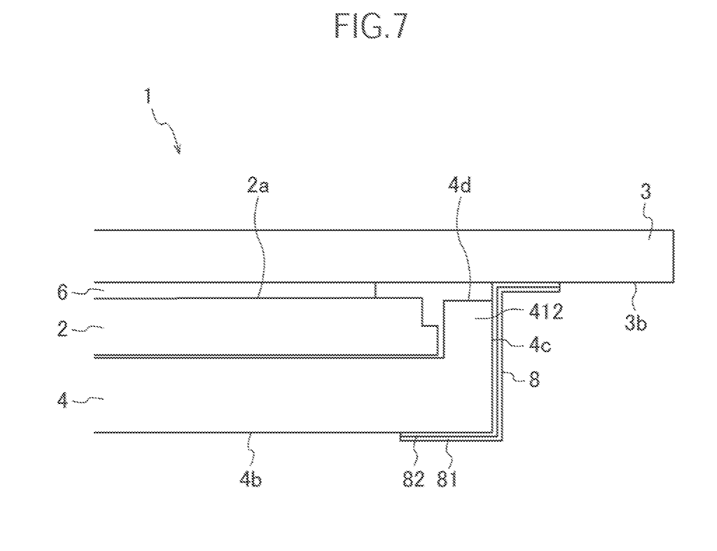

FIG. 7 is a schematic view illustrating a fixing member 8 according to another embodiment of the present application. The liquid crystal display device 1 with a touch panel includes the fixing member 8 for fixing the touch panel 3 and the backlight unit 4 to each other. The fixing member 8 is formed of, for example, adhesive tape, and includes a band-like base layer 81 formed of a sheet member made of a resin material, and an adhesive layer 82 made of a resin-based adhesive. The fixing member 8 is attached to the back surface 3b of the touch panel 3 and the back surface 4b and the side surface 4c of the backlight unit 4.

The embodiments of the present application have been described above, but the present application is not limited to the above-mentioned embodiments. It is needless to say that various modifications can be made by a person skilled in the art.

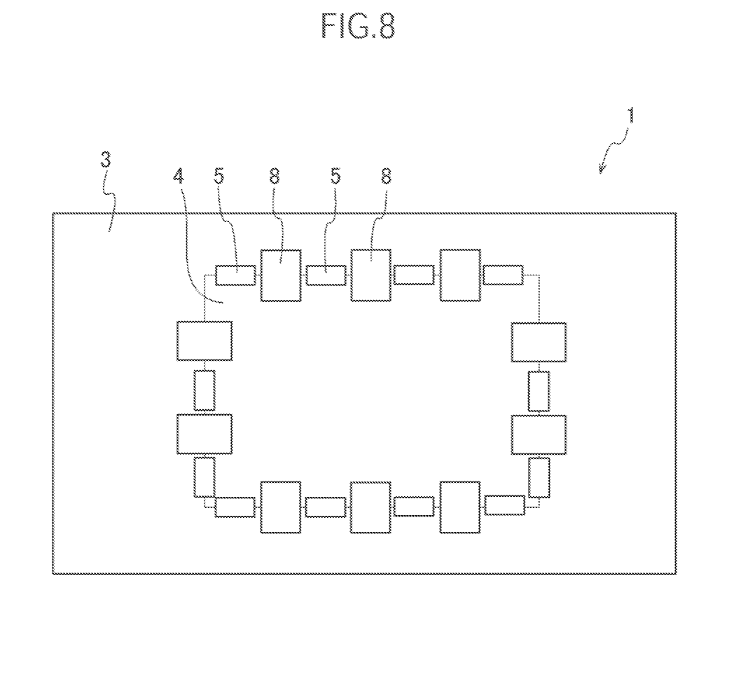

For example, both of the fixing member 5 (5A to 5D) illustrated. in any one of FIGS. 3 to 6 and the fixing member 8 illustrated in FIG. 7 may be used simultaneously. For example, as illustrated in FIG. 8, the fixing members 5 and the fixing members 8 may be alternately arranged along the peripheral edge of the backlight unit 4.

While there have been described what are at present considered to be certain embodiments of the invention, it will be understood that various modifications. may be made thereto, and it is intended that the appended claims cover all such modifications as fall within the true spirit and scope of the invention.

What is claimed is:

1. A liquid crystal display device with a touch panel, comprising:
a liquid crystal display panel;
a touch panel attached to a display surface of the liquid crystal display panel through intermediation of an adhesive layer;
a backlight unit arranged on a back surface side of the liquid crystal display panel; and
a fixing member for fixing the liquid crystal display panel and the backlight unit to each other,
the fixing member comprising:
a first end portion attached to a peripheral edge portion of the display surface of the liquid crystal display panel, the peripheral edge portion being devoid of the adhesive layer;
a second end portion attached to an outer surface of the backlight unit; and
a non-adhesive portion located between the first end portion and the second end portion, the non-adhesive portion being brought into contact with the outer surface of the backlight unit and prevented from adhering to the outer surface.

2. The liquid crystal display device with a to panel according to claim 1,
wherein the fixing member comprises adhesive tape in which the first end portion includes an adhesive laver, and a part other than the first end portion is devoid of the adhesive layer, and
wherein the second end portion is attached to the outer surface of the backlight unit by a separate adhesive member.

3. The liquid crystal display device with a touch panel according to claim 1, wherein the fixing member comprises adhesive tape in which each of the first end portion and the second end portion includes an adhesive laver, and a part between the first end portion and the second end portion is devoid of the adhesive layer.

4. The liquid crystal display device with a touch panel according to claim 1, wherein the fixing member comprises an L-shaped rigid member comprising:
a first side portion including the first end portion, the first side portion being opposed to the touch panel; and
a second side portion including the second end portion, the second side portion being opposed to a side surface of the backlight unit.

5. The liquid crystal display device with a touch panel according to claim 1, wherein the fixing member comprises adhesive tape that is devoid of an adhesive layer in a part coming into contact with a part of the outer surface of the backlight unit, which is opposed to the touch panel.

6. The liquid crystal display device with a touch panel according to claim 1, further comprising another fixing member attached to a back surface of the touch panel and the outer surface of the backlight unit, the another fixing member fixing the touch panel and the backlight unit to each other.

7. A liquid crystal display device with a touch panel, comprising:
a liquid crystal display panel;
a touch panel attached to a display surface of the liquid crystal display panel through intermediation of an adhesive layer;
a backlight unit arranged on a back surface side of the liquid crystal display panel; and
a fixing member for fixing the touch panel and the backlight unit to each other,
the fixing member being attached to a back surface of the touch panel and an outer surface of the backlight unit.
